(19) United States
(12) Patent Application Publication
(10) Pub. No.: US 2025/0260974 A1
(43) Pub. Date: Aug. 14, 2025

(54) RANDOM INTERCHANGE NUMBER GENERATOR (RING)

(71) Applicant: Wells Fargo Bank, N.A., San Francisco, CA (US)

(72) Inventor: Jeffrey J. Stapleton, O'Fallon, MO (US)

(73) Assignee: Wells Fargo Bank, N.A., San Francisco, CA (US)

(21) Appl. No.: 18/437,133

(22) Filed: Feb. 8, 2024

(51) Int. Cl. H04W 12/0431; H04W 12/041; H04W 12/102

(52) U.S. Cl. CPC H04W 12/0431; H04W 12/041; H04W 12/102

(57) ABSTRACT

The arrangements disclosed herein relate to systems, apparatus, methods, and non-transitory computer readable media for sending, by a roving cryptography device to a first user device of a plurality of user devices, a first cryptographic material when the roving cryptography device is at a first location along a path of the roving cryptography device and sending, by the roving cryptography device to a second user device of the plurality of user devices, a second cryptographic material when the roving cryptography device is at a second location along the path of the roving cryptography device. The first location and the second location are different locations. The first user device and the second user device establish a cryptographic key using the first cryptographic material and the second cryptographic material.

### BACKGROUND

Distribution of cryptographic material depends on the key management method and/or the distribution mechanism. Landline communications (e.g., communications via cables) are vulnerable to eavesdropping given that physical media can be physically tapped or close proximity scanned. Further, the Internet or other land-based communication networks are notorious for anonymous monitoring. Wireless communications can be easily monitored from close proximity to far away distances. Satellite and other restricted broadband connections need line of sight to eavesdrop or intercept communications.

### SUMMARY

The arrangements disclosed herein relate to systems, methods, non-transitory computer-readable media, and apparatuses for sending, by a roving cryptography device to a first user device of a plurality of user devices, a first cryptographic material when the roving cryptography device is at a first location along a path of the roving cryptography device and sending, by the roving cryptography device to a second user device of the plurality of user devices, a second cryptographic material when the roving cryptography device is at a second location along the path of the roving cryptography device. The first location and the second location are different locations. The first user device and the second user device establish a cryptographic key using the first cryptographic material and the second cryptographic material.

The arrangements disclosed herein relate to systems, methods, non-transitory computer-readable media, and apparatuses for receiving, by a roving cryptography device from a first user device, an encrypted signed random number generated by the first user device when the roving cryptography device is at a first location along a path of the roving cryptography device. A signature on the random number is signed by the first user device using a private key of the first user device. The signed random number is encrypted using a public key of the first roving cryptography device. The roving cryptography device decrypts the encrypted signed random number using a private key of the roving cryptography device. The roving cryptography device encrypts the signed random number using a public key of a second user device to generate a re-encrypted signed random number. The roving cryptography device sends to the second user device the re-encrypted signed random number when the roving cryptography device is at a second location along the path of the roving cryptography device. The first location and the second location are different locations.

These and other features, together with the organization and manner of operation thereof, will become apparent from the following detailed description when taken in conjunction with the accompanying drawings.

### BRIEF DESCRIPTION OF THE DRAWINGS

FIG. 1 is a diagram illustrating a method for a roving cryptography device to provide cryptographic material to user devices, according to various arrangements.

FIG. 2 is a diagram illustrating a method for a roving cryptography device to provide cryptographic material to user devices, according to various arrangements.

FIG. 3 is a diagram illustrating a method for a roving cryptography device to provide cryptographic material to a plurality of user devices, according to various arrangements.

FIG. 4 is a diagram illustrating a method for a roving cryptography device to provide cryptographic material to a plurality of user devices, according to various arrangements.

FIG. 5 is a diagram illustrating a method for a roving cryptography device to provide cryptographic material to a plurality of user devices, according to various arrangements.

FIG. 6 is a diagram illustrating a method for a roving cryptography device to provide cryptographic material to a plurality of user devices, according to various arrangements.

FIG. 7 is a diagram illustrating a method for a roving cryptography device to provide cryptographic materials to a plurality of user devices, according to various arrangements.

FIG. 8 is a flowchart diagram illustrating a method for a roving cryptography device to provide cryptographic materials to a plurality of user devices, according to various arrangements.

FIG. 9 is a flowchart diagram illustrating a method for a roving cryptography to provide cryptographic materials to a plurality of user devices, according to various arrangements.

FIG. 10 illustrates block diagrams of an example roving cryptography device 1000 and a user device 1020, according to some arrangements.

### DETAILED DESCRIPTION

The arrangements disclosed herein relate to systems, apparatuses, methods, and non-transitory computer-readable media for interchanging cryptographic materials (e.g., random numbers) and generating cryptographic keys among parties using the cryptographic materials, thus achieving key distribution independence. For example, third party Random Interchange Number Generator (RING) can provide a same cryptographic material (e.g., a same random number) to a plurality of user devices including a first user device (e.g., a first party or a first-party device) and a second user device (e.g., a second party or a second-party device). The plurality of user devices can establish a cryptographic key using the random number via a key establishment method (e.g., one of multiple suitable key establishment methods), which is common and known by the plurality of user devices but not necessarily known by the RING. By using a roving cryptography device such as a satellite, risk of attacks over landline communications, the Internet, or conventional wireless communications can be significantly reduced.

In some examples, cryptographic material as used herein refers to any tangible information that can be used in cryptographic operations (e.g., cryptographic processes or cryptographic algorithms) to encrypt, decrypt, sign, signcrypt, validate, authenticate, or protect sensitive information. Examples of the cryptographic material include a cryptographic key (e.g., a private key, a public key, a symmetric key, an asymmetric key, a secret key, a key encryption key, and so on), information (e.g., a secret parameter, a random number, a seed, a key component, a key share, an initialization vector, and so on) used to generate or derive a cryptographic key, authentication code, and so on.

In some examples, the RING can be included in a roving cryptography device such as a drone, an Unmanned Ariel Vehicle (UAV), an Unmanned Ground Vehicle (UGV), an Unmanned Maritime Vehicle (UMV), airplanes, gliders, a satellite (e.g., a Lower Earth Orbit (LEO) satellite, a Geosynchronous Equatorial Orbit (GEO) satellite, a Medium Earth Orbit (MEO), and so on), a High Altitude Platform System (HAPS), and so on. In some examples, each of the plurality of user devices can include a base station, a ground station, a desktop computer, a laptop computer, a smart phone, a tablet, server, an on-premise computing system, a datacenter, a cloud computing system, and so on. Examples of a base station or ground station include an Evolved Node B (eNB), a next Generation Node B (gNB), a Transmission/Reception Point (TRP), an Access Point (AP), a Reconfigurable Intelligent Surface (RIS), and so on that are located on the surface of the Earth. For example, a LEO satellite can send a random number to two base stations, which negotiate a cryptographic key using that random number. The satellite can send and/or receive cryptographic materials sequentially for the same or different user devices during its LEO.

In some examples, a roving cryptography device can generate a random number R_{K} and provides the same to a first user device and a second user device for those user devices to perform key establishment. In some examples, the roving cryptography device (e.g., the RING) can use a Non-deterministic Random Bit Generator (NRBG), a Quantum-Based Random Numbers (QRNG) with a suitable entropy source, or a Deterministic Random Bit Generator (DRBG) (in the examples in which the seed for the DRBG is provided to the roving cryptography device from a Cryptography Operations Center (COC). The first user device and the second user device can use the random number R_{K} to establish a cryptographic key using one or more key establishment methods.

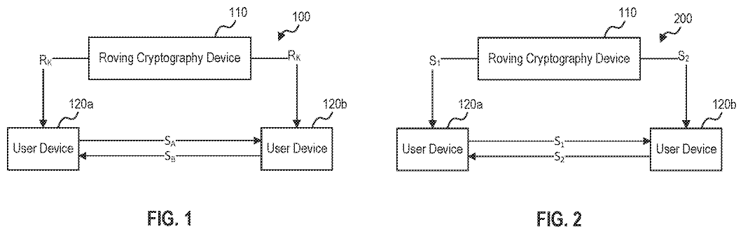

FIG. 1 is a diagram illustrating a method 100 for a roving cryptography device 110 to provide cryptographic material (e.g., a random number Rx) to user devices 120a and 120b, according to various arrangements. An example of the roving cryptography device 110 includes a RING.

In some arrangements, in the method 100, the roving cryptography device 110 can provide the random number R_{K} to be used by the user devices 120a and 120b as a key component, key share, or some other critical security parameter used to derive a cryptographic key. The roving cryptography device 110 can generate the random number R_{K} and send the random number R_{K} to each of the user devices 120a and 120b via a suitable network.

The user device 120a generates a key component S_{A}, where S_{A}=R_{A}⊕R_{K}. R_{A} is a random number generated by the user device 120a. The user device 120a sends the key component S_{A} to the user device 120b via a suitable network. The user device 120b can recover R_{A} by XORing the received S_{A} with the commonly received Rx, e.g., R_{A}=S_{A}⊕R_{K}. The user device 120b can accordingly compute a shared secret S_{X}, where S_{X}=R_{B}⊕R_{A}. The user device 120b generates a key component S_{B}, where S_{B} R_{B} R_{K}. R_{B} is a random number generated by the user device 120b. The user device 120b sends the key component S_{B} to the user device 120a via a suitable network. The user device 120a can recover R_{B} by XORing the received S_{B} with the commonly received Rx, e.g., R_{B}=S_{B} ⊕R_{K}. The user device 120a can accordingly compute the shared secret S_{X}, where S_{X}=R_{A} ⊕R_{B}. The user devices 120a and 120b can each derive a cryptographic key using the shared secret S_{X}, for example, by inputting S_{X} into a same, identical, or substantially identical Key Derivation Function (KDF). Accordingly, the user devices 120a and 120b can generate the same, identical, or substantially identical symmetric cryptographic key independently, without sharing the cryptographic key or the shared secret S_{X} via any network.

As used herein, the symbol ⊕ denotes exclusive OR (XOR), which is a bit-wise operation with two input bits and one output bit. In the examples in which the two input bits are the same, identical, or substantially identical, the output is a “0” bit, e.g., 0⊕0=0 and 1⊕1=0. In the examples in which the two input bits are different, the output is a “1” bit, e.g., 0 ⊕1=1 and 1 ⊕0=1. XOR is a cryptographic primitive used in many key derivation algorithms and key management schemes. XOR is also used in electronic gates, along with other logical operators such AND, OR, and many other gates. In some examples, a value XORed with itself yields zero bits, e.g., 1100 ⊕1100=0000. In some examples in which a first value (e.g., 1100) that is XORed with a second value (e.g., 0110) to generate a third value (e.g., 1100⊕0110=1010), the first value can be recovered by XORing the third value with the second value, e.g., 1010⊕0110=1100.

As used herein, a KDF includes any algorithm that generates a cryptographic key from input parameters such as a shared secret. Some KDFs are based on Public Key Cryptography Standard (PKCS) #5. PKCS #5 describes two Password Based Key Derivation Functions (PBKDFs), e.g., PBKDF1 and PBKDF2. A PBKDF accept a password, a random number referred to as a salt, and an iteration count as input parameters. The shared secret can include the salt. The password is appended to the salt, repetitively hashed according to the iteration count to output a cryptographic key. A KDF based on hash algorithms can include a one-way function. That is, given an output, the original input parameter cannot feasibly be determined beyond sheer exhaustive searching.

In some arrangements, in the method 100, the roving cryptography device 110 can provide the random number R_{K} to be used by the user devices 120a and 120b to derive a domain parameter for an asymmetric scheme. For example, the user devices 120a and 120b can agree on a modulus p and a base g. The user devices 120a and 120b can use the received R_{K} to derive a prime number and primitive root domain parameters. For example, the user device 120a uses R_{K} to derive domain parameters, generates random private key a, and computes its public key A according to:

A=g^{a} mod p (1),

and sends the public key A to the user device 120b. The user device 120b can compute its shared secret according to:

$${A}^{b} mod p = ( {g}^{a} ) mod p = {g}^{ab} mod p , \qquad ( 2 )$$

and derives a symmetric cryptographic key by inputting the shared secret into a KDF.

The user device 120b uses R_{K} to derive domain parameters, generates random private key b, and computes its public key B according to:

$$B = {g}^{b} mod p , \qquad ( 3 )$$

and sends the public key B to the user device 120a. The user device 120a can compute its shared secret according to:

$${B}^{a} mod p = {( {g}^{b} )}^{a} mod p = {g}^{ba} mod p , \qquad ( 4 )$$

and derives a symmetric cryptographic key by inputting the shared secret into a KDF. Accordingly, the user devices 120a and 120b can generate the same, identical, or substantially identical symmetric cryptographic key independently, without sharing the cryptographic key, the random keys, the domain parameters, or the shared secret via any network. The user devices 120a and 120b can encrypt, decrypt, sign, verify, authenticate, or signcrypt data communicated between the user devices 120a and 120b using the cryptographic key

FIG. 2 is a diagram illustrating a method 100 for a roving cryptography device 110 to provide cryptographic material (e.g., key shares S₁ and S₂) to user devices 120a and 120b, according to various arrangements. An example of the roving cryptography device 110 includes a RING.

In some arrangements, in the method 200, the roving cryptography device 110 can provide the key shares S₁ and S₂ to the user devices 120a and 120b to derive a cryptographic key. The roving cryptography device 110 can generate the random number R_{K} and use R_{K} as a secret to create a polynomial of order N−1 with M points on a curve, such that any N points are sufficient to determine the polynomial and solve for the secret. The roving cryptography device 110 can generate a total of M (e.g., 3) key shares (e.g., S₁, S₂, and S₃), such that N (e.g., 2) shares (e.g., S₁ and S₂) are sufficient to determine the polynomial and derive a shared secret. The roving cryptography device 110 sends a first share S₁ to the user device 120a via a suitable network and a second share S₂ to the user device 120b via a suitable network. The third share S₃ can be discarded. In some examples, N is a number of the plurality of user devices, and M is greater than N.

The user device 120a sends the first share S₁ to the user device 120b. The user device 120b uses the shares S₁ and S₂ to determine the polynomial and solve for the shared secret R_{K}. The user device 120b sends the second share S₂ to the user device 120a. The user device 120a uses the shares S₁ and S₂ to determine the polynomial and solve for the shared secret R_{K}. The user devices 120a and 120b can each derive a cryptographic key using the shared secret R_{K}, for example, by inputting R_{K} into a same, identical, or substantially identical KDF. The user devices 120a and 120b can encrypt, decrypt, sign, verify, authenticate, or signcrypt data communicated between the user devices 120a and 120b using that cryptographic key. Accordingly, the user devices 120a and 120b can generate the same, identical, or substantially identical symmetric cryptographic key independently, without sharing the cryptographic key or the shared secret R_{K} via any network.

In some arrangements, other key establishment schemes can be implemented by the user devices 120a and 120b using the random number R_{K} provided by the roving cryptography device 110.

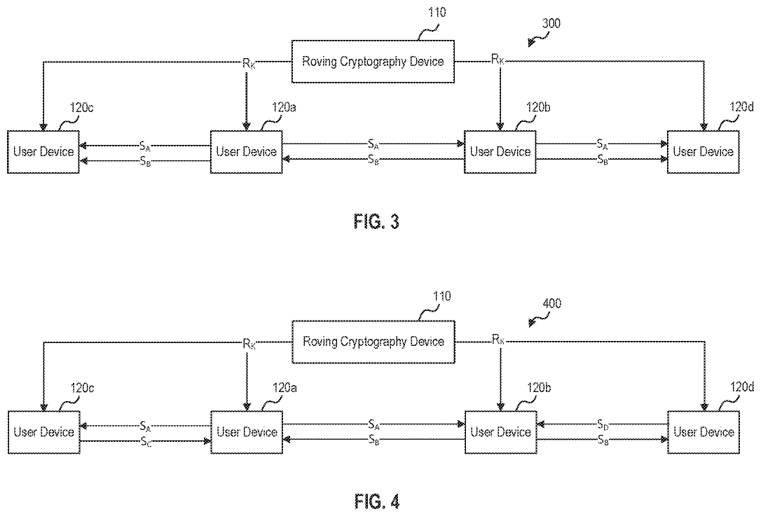

FIG. 3 is a diagram illustrating a method 300 for a roving cryptography device 110 to provide cryptographic material (e.g., a random number R_{K}) to a plurality of user devices 120a, 120b, 120c, and 120d, according to various arrangements. An example of the roving cryptography device 110 includes a RING.

In some arrangements, in the method 300, the roving cryptography device 110 can provide the random number R_{K} to be used by the user devices 120a, 120b, 120c, and 120d as a key component or used to derive a key component, to derive a domain parameter for an asymmetric scheme. The roving cryptography device 110 can generate the random number R_{K} and send the random number R_{K} to each of the user devices 120a, 120b, 120c, and 120d via a suitable network.

The user device 120a generates a key component S_{A}, where S_{A}=R_{A}⊕R_{K}. R_{A} is a random number generated by the user device 120a. The user device 120a sends the key component S_{A} to the user device 120b via a suitable network and to the user device 120c via a suitable network. The user device 120b can forward or relay the key component S_{A} to the user device 120d via a suitable network. Each of the user devices 120b, 120c, and 120d can recover R_{A} by XORing the received S_{A} with the commonly received R_{K}, e.g., R_{A}=S_{A}⊕R_{K}. Each of the user devices 120b, 120c, and 120d can accordingly compute a shared secret S_{X}, where S_{X}=R_{B}⊕R_{A}.

The user device 120b generates a key component S_{B}, where S_{B} R_{B} R_{K}. R_{B} is a random number generated by the user device 120b. The user device 120b sends the key component S_{B} to the user device 120a via a suitable network and to the user device 120d via a suitable network. The user device 120a can forward or relay the key component S_{B} to the user device 120c via a suitable network. Each of the user devices 120a, 120c, and 120d can recover R_{B} by XORing the received S_{B} with the commonly received R_{K}, e.g., R_{B}=S_{B} ⊕R_{K}. Each of the user devices 120a, 120c, and 120d can accordingly compute the shared secret S_{X}, where S_{X}=R_{A}⊕R_{B}. The user devices 120a, 120b, 120c, and 120d can each derive a cryptographic key using the shared secret S_{X}, for example, by inputting S_{X} into a same, identical, or substantially identical KDF. Accordingly, the user devices 120a, 120b, 120c, and 120d can generate the same, identical, or substantially identical symmetric cryptographic key independently, without sharing the cryptographic key or the shared secret S_{X} via any network.

In some arrangements, in the method 300, the roving cryptography device 110 can provide the random number R_{K} to be used by the user devices 120a and 120b to derive a domain parameter for an asymmetric scheme. For example, the user devices 120a, 120b, 120c, and 120d can agree on a modulus p and a base g. The user devices 120a and 120b can use the received R_{K} to derive a prime number and primitive root domain parameters. For example, the user device 120a uses R_{K} to derive domain parameters, generates random private key a, and computes its public key A according to expression (1) and sends the public key A to the user device 120b via a suitable network and to the user device 120c via a suitable network. The user device 120b can forward or relay the public key A to the user device 120d via a suitable network. The user device 120b uses R_{K} to derive domain parameters, generates random private key b, and computes its public key B according to expression (3) and sends the public key B to the user device 120a via a suitable network and to the user device 120d via a suitable network. The user device 120a can forward or relay the public key A to the user device 120c via a suitable network. Each of the user devices 120a, 120b, 120c, and 120d can compute its shared secret according to expression (2) or (4) and derives a symmetric cryptographic key by inputting the shared secret into a KDF. Accordingly, the user devices 120a, 120b, 120c, and 120d can generate the same, identical, or substantially identical symmetric cryptographic key independently, without sharing the cryptographic key, the random keys, the domain parameters, or the shared secret via any network.

In some examples, instead of R_{K}, the roving cryptography device 110 can provide shares instead of R_{K} as described relative to FIG. 2. In some arrangements, in the roving cryptography device 110 can provide the key shares S₁, S₂, S₃, and S₄ to the user devices 120a, 120b, 120c, and 120d to derive a cryptographic key. The roving cryptography device 110 can generate the random number R_{K} and use R_{K} as a secret to create a polynomial of order N−1 with M points on a curve, such that any N points are sufficient to determine the polynomial and solve for the secret. The roving cryptography device 110 can generate a total of (e.g., 5) key shares (e.g., S₁, S₂, S₃, S₄, and S₅), such that N (e.g., 4) shares (e.g., S₁, S₂, S₃, and S₄) are sufficient to determine the polynomial and derive a shared secret. The roving cryptography device 110 sends a first share S₁ to the user device 120a via a suitable network, a second share S₂ to the user device 120b via a suitable network, a third share S₃ to the user device 120c via a suitable network, and a fourth share S₄ to the user device 120d via a suitable network. The fifth share S₅ can be discarded. In some examples, N is a number of the plurality of user devices, and M is greater than N. Each of the user devices 120a, 120b, 120c, and 120d receives the shares of the other three user devices and uses the N shares S₁, S₂, S₃, and S₄ to determine the polynomial and solve for the shared secret R_{K}. The user devices 120a, 120b, 120c, and 120d can each derive a cryptographic key using the shared secret R_{K}, for example, by inputting R_{K} into a same, identical, or substantially identical KDF. The user devices 120a, 120b, 120c, and 120d can encrypt, decrypt, sign, verify, authenticate, or signcrypt data communicated among the user devices 120a, 120b, 120c, and 120d using that cryptographic key. Accordingly, the user devices 120a, 120b, 120c, and 120d can generate the same, identical, or substantially identical symmetric cryptographic key independently, without sharing the cryptographic key or the shared secret R_{K} via any network.

FIG. 4 is a diagram illustrating a method 400 for a roving cryptography device 110 to provide cryptographic material (e.g., a random number R_{K}) to a plurality of user devices 120a, 120b, 120c, and 120d, according to various arrangements. An example of the roving cryptography device 110 includes a RING.

In some arrangements, in the method 400, the roving cryptography device 110 can provide the random number R_{K} to be used by the user devices 120a, 120b, 120c, and 120d as a key component or used to derive a key component, to derive a domain parameter for an asymmetric scheme. The roving cryptography device 110 can generate the random number R_{K} and send the random number R_{K} to each of the user devices 120a, 120b, 120c, and 120d via a suitable network.

The user device 120a generates a key component S_{A}, where S_{A}=R_{A}⊕R_{K}. R_{A} is a random number generated by the user device 120a. The user device 120a sends the key component S_{A} to the user device 120b via a suitable network and to the user device 120c via a suitable network. Each of the user devices 120b and 120c can recover R_{A} by XORing the received S_{A} with the commonly received R_{K}, e.g., R_{A}=S_{A}⊕R_{K}. The user device 120b can compute a shared secret S_{X}, where S_{X}=R_{B}⊕R_{A}. The user device 120c can compute a shared secret S_{Y}, where S_{X}=R_{C} ⊕R_{A} and R_{C} is a random number generated by the user device 120c.

The user device 120b generates a key component S_{B}, where S_{B}=R_{B}⊕R_{K}. R_{B} is a random number generated by the user device 120b. The user device 120b sends the key component S_{B} to the user device 120a via a suitable network and to the user device 120d via a suitable network. Each of the user devices 120a and 120d can recover R_{B} by XORing the received S_{B} with the commonly received R_{K}, e.g., R_{B} SS_{B} R_{K}. The user device 120a can compute the shared secret S_{X}, where S_{X}=R_{A}⊕R_{B}. The user device 120d can compute a shared secret S_{Z}, where S_{Z}=R_{D} ⊕R_{B} and R_{D} is a random number generated by the user device 120d.

The user device 120c generates a key component S_{C}, where S_{C}=R_{C} ⊕R_{K}. The user device 120c sends the key component S_{C} to the user device 120a via a suitable network. The user device 120a can recover R_{C} by XORing the received S_{C} with the commonly received R_{K}, e.g., R_{C}=S_{C}⊕R_{K}. The user device 120a can compute the shared secret S_{Y}, where S_{Y}=R_{A}⊕R_{C}. The user device 120d generates a key component S_{D}, where S_{D}=R_{D} ⊕R_{K}. The user device 120d sends the key component S_{D} to the user device 120b via a suitable network. The user device 120b can recover R_{D} by XORing the received S_{D} with the commonly received R_{K}, e.g., R_{D}=S_{D} ⊕R_{K}. The user device 120b can compute the shared secret S_{Z}, where S_{Z}=R_{B} ⊕R_{D}.

This enables separate group keys for different groups based on different shared secrets. For example, the user devices 120a and 120b can each derive a cryptographic key using the shared secret S_{X}, for example, by inputting S_{X} into a same, identical, or substantially identical KDF. The user devices 120a and 120b can encrypt, decrypt, sign, verify, authenticate, or signcrypt data communicated between the user devices 120a and 120b using that cryptographic key. The user devices 120a and 120c can each derive a cryptographic key using the shared secret S_{Y}, for example, by inputting S_{Y} into a same, identical, or substantially identical KDF. The user devices 120a and 120c can encrypt, decrypt, sign, verify, authenticate, or signcrypt data communicated between the user devices 120a and 120c using that cryptographic key. The user devices 120b and 120d can each derive a cryptographic key using the shared secret S_{Z}, for example, by inputting S_{Z} into a same, identical, or substantially identical KDF. The user devices 120b and 120d can encrypt, decrypt, sign, verify, authenticate, or signerypt data communicated between the user devices 120b and 120d using that cryptographic key. Accordingly, the user devices 120a, 120b, 120c, and 120d in the same group can generate the s same, identical, or substantially identical ame symmetric cryptographic key independently, without sharing the cryptographic key or the shared secret S_{X} via any network.

In some examples, the roving cryptography device 110 can include devices or systems that are self-propelled and/or configured to move in a predetermined path or a dynamically defined path. In some examples, the roving cryptography device 110 include a GEO satellite, which is also referred to as a geostationary satellite. A GEO satellite can move at the same velocity as the Earth and on a path that is parallel to the Earth's rotation, thus appearing to be stationary in the sky from a given point on the surface of the Earth. This enables a GEO satellite to provide coverage to a specific area of the Earth. Orbiting at around 35,000 km above the surface of the Earth, GEO satellites take precisely 24 hours to perform a complete orbit of the Earth. As the largest type of satellite and the great distance at which they orbit the Earth, only three GEO satellites are needed for complete communications coverage for the entire Earth.

The user devices described herein can be located along or adjacent to the path of the roving cryptography device 110 on the surface of the Earth to receive the cryptographic material when the roving cryptography device 110 moves to various locations along the path. The user devices can receive the same, identical, or substantially identical cryptographic material sequentially as the roving cryptography device 110 moves along the path. For example, the roving cryptography device 110 can include a LEO satellite. LEO satellites occupy the lowest orbit of all satellite types, often between 800-1,600 km above the surface of the Earth. This proximity to Earth makes them ideal for very high-speed, low-latency communications, often exhibiting a delay of just 0.05 seconds. The sizes of LEO satellites tend to be very small, making them much quicker and cheaper to produce than GEO satellites. LEO satellites fly much faster than GEO satellites, completing an orbit in as little as 40-100 minutes. Due to the LEO satellites' proximity to the surface of the Earth, more LE) satellites than GEO satellites are needed to provide complete global coverage.

In the examples in which the roving cryptography device 110 includes a LEO satellite or another device that can move along the Earth's surface along a predetermined or dynamically defined path, as the roving cryptography device 110 moves along the path, the roving cryptography device 110 can communicate with each user device (e.g., a ground unit) for a period of time (e.g., several minutes) to send cryptographic materials to and/or receive cryptographic materials from each user device, enabling key establishment among the user devices. Depending on the RING method, an attacker is required to eavesdrop on at least two communication points, or the attacker has no access points. For example, in FIGS. 1-5, the roving cryptography device 110 can send the cryptographic materials to the user devices at different locations along the path. For example, the roving cryptography device can send a first cryptographic material to a first user device when the roving cryptography device is at a first location along a path of the roving cryptography device, and subsequently, the roving cryptography device can send a second cryptographic material to a second user device when the roving cryptography device is at a second location along a path of the roving cryptography device.

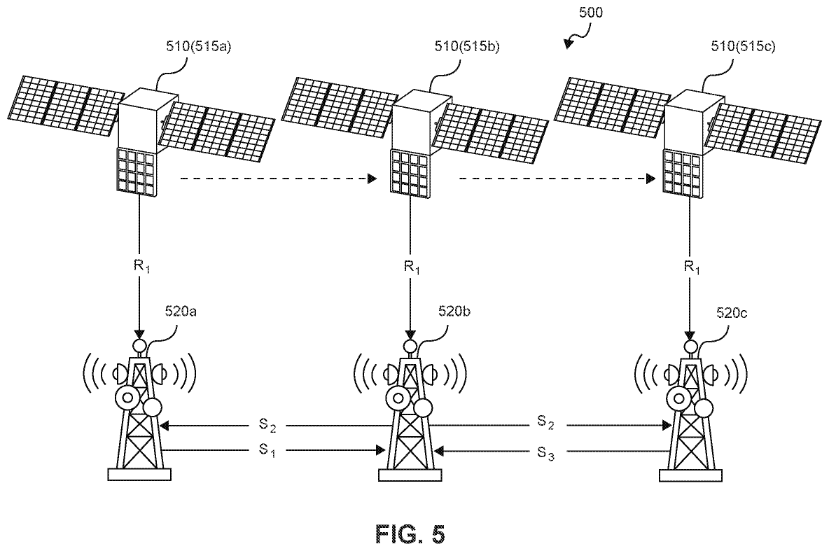

FIG. 5 is a diagram illustrating a method 500 for a roving cryptography device 510 to provide cryptographic material (e.g., a random number R₁) to a plurality of user devices 520a, 520b, and 520c, according to various arrangements. An example of the roving cryptography device 510 includes a RING and the roving cryptography device 110. Each of the user devices 520a, 520b, and 520c can be a user device such as the user devices 120a, 120b, 120c, and 120d. While the roving cryptography device 510 is shown to be a LEO satellite and the user devices 520a, 520b, and 520c are shown to be base stations, the roving cryptography device 510 can be any type of roving cryptography devices described herein that moves along a path including the locations 515a, 515b, and 515c, and the user devices 520a, 520b, and 520c can be any type of user devices (stationary or mobile) described herein that can receive cryptographic materials from the roving cryptography device 510 when the roving cryptography device 510 is at the locations 515a, 515b, and 515c respectively.

The path of the roving cryptography device 510 can be predetermined in some examples, such that designated user devices 520a, 520b, and 520c with known stationary locations on the surface of the Earth can be within the range of the roving cryptography device 510 for receiving the cryptographic materials. The path of the roving cryptography device 510 can be dynamically determined in some examples, and the roving cryptography device 510 can be moved by its locomotion system to be within proximity of the stationary or dynamic locations of the user devices 520a, 520b, and 520c on the surface of the Earth for providing the cryptographic materials.

As shown, the roving cryptography device 510 can move along a path (e.g., LEO) defined by various points including the locations 515a, 515b, and 515c. Each of the locations 515a, 515b, and 515c represents a location of the roving cryptography device 510 at which the user devices 520a, 520b, and 520c can receive cryptographic material. In that regard, each of the locations 515a, 515b, and 515c can include a plurality of locations or a designated section of the path. At location 515a, the roving cryptography device 510 can send a random number R₁ to the user device 520a. Subsequently, the roving cryptography device 510 moves along the path to location 515b, at which the roving cryptography device 510 can send the random number R₁ to the user device 520b. Subsequently, the roving cryptography device 510 moves along the path to location 515c, at which the roving cryptography device 510 can send the random number R₁ to the user device 520c. Accordingly, the user devices 520a, 520b, and 520c receive the same, identical, or substantially identical cryptographic material at different times, and in sequence, as the roving cryptography device 510 moves along the path.

After sequentially receiving the random number R₁ from the roving cryptography device 510, each of the user devices 520a, 520b, and 520c generates a shared secret S by combining (e.g., XORing) the received random number (R₁) with a second random number (e.g., respective ones of R₂, R₃, R₄) generated by each of the user devices 520a, 520b, and 520c. For example, the user device 520a determines S₁=(R₁⊕R₂). The user device 520b determines S₂=(R₁ ⊕R₃). The user device 520c determines S₃=(R₁⊕R₄). Each station pair exchanges shared secrets. Each station pair can include two or more user devices (e.g., base stations) that are within communication range (e.g., wired or wireless communication range) of one another. For example, a first station pair can include the user devices 520a and 520b, and a second station pair can include the user devices 520b and 520c. The user device 520a and 520b may not be within communication range of one another.

Given that each shared secret is determined using random number R₁ as one of its components, each user device can determine the random numbers R₂, R₃, R₄ of other user devices. For example, the user device 520a can receive the shared secret S₂ from the user device 520b and determines R₃ of the user device 520b according to R₃=(S₂ ⊕R₁). The user device 520c can receive the shared secret S₂ from the user device 520b and determines R₃ of the user device 520b according to R₃=(S₂ ⊕R₁). The user device 520b can receive the shared secret S₁ from the user device 520a and determines R₂ of the user device 520a according to R₂=(S₁⊕R₁). The user device 520b can receive the secret S₃ from the user device 520c and determines R₄ of the user device 520c according to R₄=(S₃ ⊕R₁).

This enables each user device to generate a shared key K. For example, each of the user devices 520a and 520b can generate shared key K_{A}=(R₂ ⊕R₃), and each of the user devices 520b and 520c can generate shared key K_{B}=(R₃ ⊕R₄). The user devices 120a and 120b can encrypt, decrypt, sign, verify, authenticate, or signcrypt data communicated between the user devices 120a and 120b using the shared key K_{A}. The user devices 120b and 120c can encrypt, decrypt, sign, verify, authenticate, or signcrypt data communicated between the user devices 120b and 120c using the shared key K_{B}. In some examples, in response to the last user device (e.g., the user device 520c) receiving the random number R₁, the roving cryptography device 510 erases the random number R₁, generates another random number R₅, and the distribution repeats with the new random number R₅ for the next iteration of the path (e.g., the next orbiting instance) at the user device 520a.

In this case, an attacker would be required to eavesdrop on both the link between the satellite 510 and one of the user devices 520a, 520b, and 520c and the link between two of the user devices 520a, 520b, and 520c at different times in order to obtain the information needed to derive the shared key. Given that the link between the satellite 510 and one of the user devices 520a, 520b, and 520c and the link between two of the user devices 520a, 520b, and 520c are different types of communication links and require different types of hardware, the difficulties that an attacker faces in order to obtain the shared key is substantially increased.

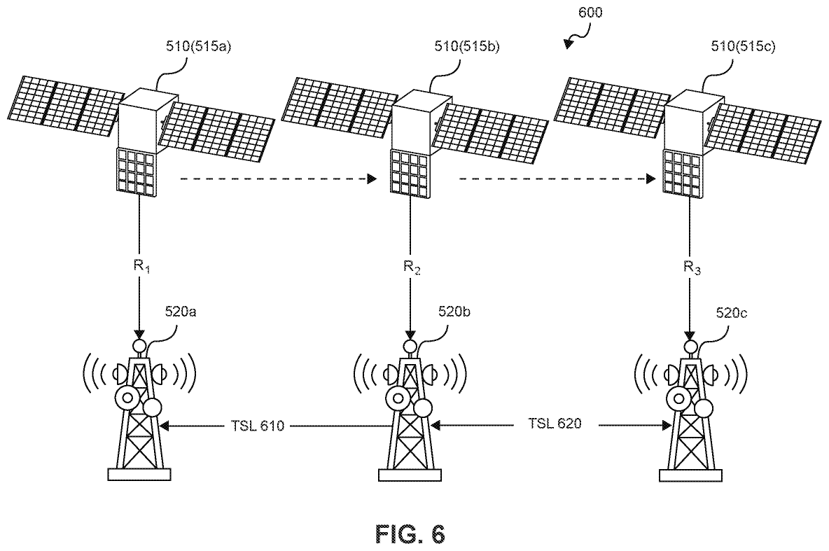

FIG. 6 is a diagram illustrating a method 600 for a roving cryptography device 510 to provide cryptographic material (e.g., random numbers R₁, R₂, R₃) to a plurality of user devices 520a, 520b, and 520c, according to various arrangements. While the roving cryptography device 510 is shown to be a LEO satellite and the user devices 520a, 520b, and 520c are shown to be base stations, the roving cryptography device 510 can be any type of roving cryptography devices described herein that moves along a path including the locations 515a, 515b, and 515c, and the user devices 520a, 520b, and 520c can be any type of user devices (stationary or mobile) described herein that can receive cryptographic materials from the roving cryptography device 510 when the roving cryptography device 510 is at the locations 515a, 515b, and 515c respectively.

In the method 600, instead of sending the same, identical, or substantially identical same random number to the user devices 520a, 520b, and 520c, the roving cryptography device 510 sends different random numbers to respective ones of the user devices 520a, 520b, and 520c. For example, at location 515a, the roving cryptography device 510 can send a random number R₂ to the user device 520a. Subsequently, the roving cryptography device 510 moves along the path to location 515b, at which the roving cryptography device 510 can send the random number R₂ to the user device 520b. Subsequently, the roving cryptography device 510 moves along the path to location 515c, at which the roving cryptography device 510 can send the random number R₃ to the user device 520c. Accordingly, each of the user devices 520a, 520b, and 520c receives a different cryptographic material at a different time, and in sequence, as the roving cryptography device 510 moves along the path.

After sequentially receiving the random numbers from the roving cryptography device 510, each of the user devices 520a, 520b, and 520c shares its random number with another user device via a secure connection such as a Transport Layer Security (TLS) channel. Each station pair exchanges the received random numbers. Each station pair can include two or more user devices (e.g., base stations) that are within communication range (e.g., wired or wireless communication range) of one another. For example, a first station pair can include the user devices 520a and 520b, and a second station pair can include the user devices 520b and 520c. The user device 520a and 520b may not be within communication range of one another. For example, the user device 520a sends the received random number R₁ to the user device 520b via the TLS connection 610, and the user device 520b sends the received random number R₂ to the user device 520a via the TLS connection 610. The user device 520c sends the received random number R₃ to the user device 520b via the TLS connection 620, and the user device 520b sends the received random number R₂ to the user device 520c via the TLS connection 620.

This enables each user device to generate a shared key K. For example, each of the user devices 520a and 520b can generate shared key K_{A}=(R₁ ⊕R₂), and each of the user devices 520b and 520c can generate shared key K_{B}=(R₂ ⊕R₃). The user devices 120a and 120b can encrypt, decrypt, sign, verify, authenticate, or signcrypt data communicated between the user devices 120a and 120b using the shared key K_{A}. The user devices 120b and 120c can encrypt, decrypt, sign, verify, authenticate, or signcrypt data communicated between the user devices 120b and 120c using the shared key K_{B}. In some examples, in response to the last user device (e.g., the user device 520c) receiving the random number R₃, the roving cryptography device 510 erases all random numbers for this iteration of the path (e.g., this orbit), generates another set of random numbers, and the distribution repeats with the new random number set for the next iteration of the path (e.g., the next orbiting instance) at the user device 520a. In some examples, in response to the user device receiving a current random number or before generating a next random number, that current random number is erased by the roving cryptography device 510.

In this case, an attacker would be required to eavesdrop on both the link between the satellite 510 and one of the user devices 520a, 520b, and 520c and the link between the satellite 510 and another one of the user devices 520a, 520b, and 520c at different times in order to obtain the information needed to derive the shared key. Given the distances between two user devices of a same group, the difficulties that an attacker faces in order to obtain the shared key is substantially increased.

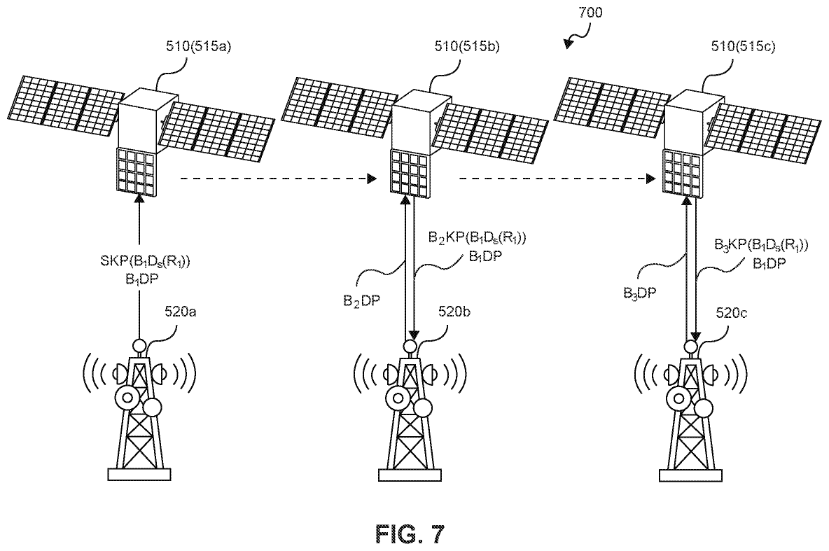

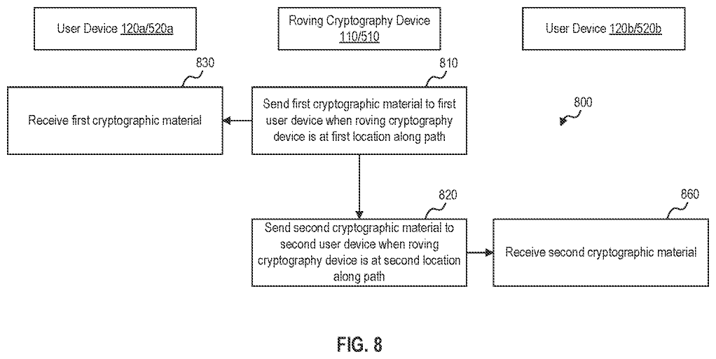

FIG. 7 is a diagram illustrating a method 700 for a roving cryptography device 510 to provide cryptographic materials to a plurality of user devices 520a, 520b, and 520c, according to various arrangements. While the roving cryptography device 510 is shown to be a LEO satellite and the user devices 520a, 520b, and 520c are shown to be base stations, the roving cryptography device 510 can be any type of roving cryptography devices described herein that moves along a path including the locations 515a, 515b, and 515c, and the user devices 520a, 520b, and 520c can be any type of user devices (stationary or mobile) described herein that can receive cryptographic materials from the roving cryptography device 510 and send cryptographic materials to the roving cryptography device 510 when the roving cryptography device 510 is at the locations 515a, 515b, and 515c respectively.

In the method 700, the user device 520a generates a random number R₁ and signs and encrypts the random number R₁ (e.g., signcrypts the random number R₁). For example, the user device 520a can sign the random number R₁ (e.g., generating a signature for the random number R₁) using a cryptographic key of the user device 520a (e.g., using Post Quantum Cryptography (PQC) private key B₁D_{S} of the user device 520a) and encrypts the signed random number B₁D_{S}(R₁) using a cryptographic key of the roving cryptography device 510 (e.g., the PQC public key SKP of the roving cryptography device 510) to generate encrypted signed random number SKP(B₁D_{S}(R₁)). The user device 520a sends SKP(B₁D_{S}(R₁)) to the roving cryptography device 510 when the roving cryptography device 510 is at location 515a. In some examples, the user device 520a can send the public key of the user device 520a, e.g., the PQC public key B₁DP, to the roving cryptography device 510 along with SKPB₁D_{S}(R₁), when the roving cryptography device 510 is at location 515a. The PQC public key and the private key of the user device 520a form a public/private key pair and are mathematically related to one another. In some examples, the public key of the of the user device 520a sent to the roving cryptography device 510 can be signed by a root base B₀DP installed on the roving cryptography device 510.

In response to receiving encrypted signed (signcrypted) random number SKPB₁D_{S}(R₁)), the roving cryptography device 510 decrypts the encrypted signed random number SKP(B₁D_{S}(R₁)) using the PQC private key of the roving cryptography device 510, re-encrypts the signed random number B₁D_{S}(R₁) using a cryptographic key of the user device 520b (e.g., the PQC public key B₂KP of the user device 520b). The PQC public key and the private key of the roving cryptography device 510 form a public/private key pair and are mathematically related to one another. Subsequently, the roving cryptography device 510 moves along the path to location 515b, at which the roving cryptography device 510 can receive additional cryptographic material from and send cryptographic material to the user device 520b. For example, the roving cryptography device 510 sends the re-encrypted and signed random number B₂KPB₁D_{S}(R₁)) to the user device 520b. In some examples, the roving cryptography device 510 can receive the PQC public key B₂KP of the user device 520b, when the roving cryptography device 510 is at location 515b.

The user device 520b decrypts the re-encrypted and signed random number B₂KPB₁D_{S}(R₁)) using a private key of the user device 520b (e.g., the PQC private key B₂Kp of the user device 520b). The PQC public key and the private key of the user device 520b form a public/private key pair and are mathematically related to one another. The user device 520b verifies the signature of the user device 520a using a public key (e.g., the PQC public key BiDP) of the user device 520a. For example, the roving cryptography device 510 can send the public key of the user device 520a to the user device 520b, when the roving cryptography device 510 is at location 515b. The user device 520b can send a public key of the user device 520b (e.g., the public key B₂DP) to the roving cryptography device 510, when the roving cryptography device 510 is at location 515b. The PQC public key and the private key of the user device 520b form a public/private key pair and are mathematically related to one another. In some examples, the public key of the of the user device 520b sent to the roving cryptography device 510 can be signed by a root base B₀DP installed on the roving cryptography device 510.

In some examples, the roving cryptography device 510 re-encrypts the signed random number B₁D_{S}(R₁) using a cryptographic key of the user device 520c (e.g., the PQC public key B₃KP of the user device 520c). Subsequently, the roving cryptography device 510 moves along the path to location 515c, at which the roving cryptography device 510 can receive additional cryptographic materials from and send cryptographic materials to the user device 520c. For example, the roving cryptography device 510 sends the re-encrypted and signed random number B₃KPB₁D_{S}(R₁)) to the user device 520c, when the roving cryptography device 510 is at location 515c. In some examples, the roving cryptography device 510 can receive the PQC public key B₃KP of the user device 520c, when the roving cryptography device 510 is at location 515c.

The user device 520c decrypts the re-encrypted and signed random number B₃KPB₁D_{S}(R₁)) using a private key of the user device 520c (e.g., the PQC private key B₃Kp of the user device 520c). The PQC public key and the private key of the user device 520c form a public/private key pair and are mathematically related to one another. The user device 520c verifies the signature of the user device 520a using a public key (e.g., the PQC public key B₁DP) of the user device 520a. For example, the roving cryptography device 510 can send the public key of the user device 520a to the user device 520c, when the roving cryptography device 510 is at location 515c. The user device 520c can send a public key of the user device 520c (e.g., the PQC public key B₃DP) to the roving cryptography device 510, when the roving cryptography device 510 is at location 515c. The PQC public key and the private key of the user device 520c form a public/private key pair and are mathematically related to one another. In some examples, the public key of the of the user device 520b sent to the roving cryptography device 510 can be signed by a root base B₀DP installed on the roving cryptography device 510.

This enables each user device to generate a shared key K using the random number R₁. For example, each of the user devices 520a, 520b, 520c can generate shared key K by inputting the random number R₁ into a KDF. The user devices 520a, 520b, 520c can encrypt, decrypt, sign, verify, authenticate, or signcrypt data communicated among the user devices 520a, 520b, 520c using the shared key K.

The method 700 enables each user device to securely receive and verify the random number, which can be used for a wide variety of purposes. For example, the random number can be inputting into a KDF to generate a cryptographic key. A random number can be used directly for Monte Carlo modeling and research. A random number can be used as One-Time-Passcodes (OTP) within authentication protocols between the user devices. Two or more random numbers can be combined to reconstruct cryptographic keys. The signed public key of each user device can be transmitted as needed to the roving cryptography device 510 and other user devices via the roving cryptography device 510, allowing for impromptu public key certificates within a RING PKI. In some examples, given that LEO satellites have a relatively short lifetime or limited communications, the various keys and certificates can be pre-installed into the satellite (e.g., the roving cryptography device 510) for distribution.

FIG. 8 is a flowchart diagram illustrating a method 800 for a roving cryptography device (e.g., 110 or 510) to provide cryptographic materials to a plurality of user devices (e.g., 120a, 120b, 120c, 120d, 520a, 520b, and 520c), according to various arrangements. The methods 500 and 600 are example implementations of the method 800. As used herein a first user device and a second user device can be any of the user devices 120a, 120b, 120c, 120d, 520a, 520b, and 520c. For example, the user device 120a or 520a can be referred to as a first user device, and the user device 120b or 520b can be referred to as a second user device. Blocks 810 and 820 can be performed by the roving cryptography device. Block 830 can be performed by the first user device. Block 860 can be performed by the second user device.

At 810, the roving cryptography device sends to a first user device of a plurality of user devices a first cryptographic material when the roving cryptography device is at a first location along a path of the roving cryptography device. At 820, the roving cryptography device sends to a second user device of the plurality of user devices a second cryptographic material when the roving cryptography device is at a second location along the path of the roving cryptography device. The first location and the second location are different locations. The first user device cannot receive any information or send any information to the roving cryptography device when the roving cryptography device is in the second location. The second user device cannot receive any information or send any information to the roving cryptography device when the roving cryptography device is in the first location. In other examples, a user device can receive information or send information to the roving cryptography device when the roving cryptography device is in a location corresponding to another user device. The first user device and the second user device establish a cryptographic key using the first cryptographic material and the second cryptographic material.

In some examples, the cryptographic material includes at least one of a random number, a key component, or a key share. In some examples, the roving cryptography device includes a drone, a UAV, a UGV, a UMV, airplanes, gliders, a satellite, or a HAPS. In some examples, each of the plurality of user devices includes a base station, a ground station, a desktop computer, a laptop computer, a smart phone, a tablet, server, an on-premise computing system, a datacenter, or a cloud computing system.

At 830, the first user device receives the first cryptographic material when the roving cryptography device is at the first location along the path. At 860, the second user device receives the second cryptographic material when the roving cryptography device is at the second location along the path.

In some arrangements such as those described with respect to the method 500, the first cryptographic material and the second cryptographic material are same, identical, or substantially identical. For example, the first cryptographic material and the second cryptographic material are a same, identical, or substantially identical first random number.

In some examples, the first user device determines a first cryptographic key using the first cryptographic material. For example, the first user device determines a first shared secret by combining (e.g., XORing) the first random number with a second random number generated by the first user device and sends the first shared secret to the second user device. In some examples, the first user device determines the third random number using the received second shared secret and the first random number (e.g., by XORing received second shared secret and the first random number). The first user device determines the first cryptographic key using the second random number and the determined third random number (e.g., by XORing) the second random number and the determined third random number.

In some examples, the second user device determines a second cryptographic key using the second cryptographic material. For example, the second user device determines a second shared secret by combining (e.g., XORing) the first random number with a third random number generated by the second user device and sends the second shared secret to the first user device. The second user device determines the second random number using the received first shared secret and the first random number (e.g., by XORing the received first shared secret and the first random number). The second user device determines the cryptographic key using the third random number and the determined second random number (e.g., by XORing the third random number and the determined second random number). The first cryptographic key and the second cryptographic key are same, identical, or substantially identical.

In some examples, the first user device can perform a cryptographic operation (e.g., with the second user device or with another user device) using the first cryptographic key. In some examples, the second user device can perform a cryptographic operation (e.g., with the first user device or with another user device) using the second cryptographic key. A cryptographic operation includes encrypting data, decrypting data, encrypting another cryptographic material (e.g., another cryptographic key), decrypting another cryptographic material, signing data, verifying data, signcrypting data, and so on. For example, one of the first user device or the second user device can encrypt, decrypt, sign, verify, or signcrypt data to be send to or data received from the other one of the first user device or the second user device.

In some examples, the method 800 further includes sending, by the roving cryptography device to a third user device (e.g., the user device 120d or 520c) of the plurality of user devices, a third cryptographic material when the roving cryptography device is at a third location along the path of the roving cryptography device. The third location is different from the first location and the second location. The second user device and the third user device establish another cryptographic key (different from the first and second cryptographic key) using the second cryptographic material and the third cryptographic material.

In some examples, the first cryptographic material, the second cryptographic material, and the third cryptographic material are a same, identical, or substantially identical first random number. The second user device determines a second shared secret by combining (e.g., XORing) the first random number with a third random number generated by the second user device and sends the second shared secret to the third user device. The third user device determines a third shared secret by combining (e.g., XORing) the first random number with a fourth random number generated by the third user device and sends the third shared secret to the second user device.

In some examples, the second user device determines the fourth random number using the received third shared secret and the first random number (e.g., by XORing the received third shared secret and the first random number). The second user device determines a third cryptographic key using the third random number and the determined fourth random number (e.g., by XORing the third random number and the determined fourth random number). The third user device determines the third random number using the received second shared secret and the first random number (e.g., by XORing the received second shared secret and the first random number). The second user device determines the fourth cryptographic key using the fourth random number and the determined third random number (e.g., by XORing the fourth random number and the determined third random number). The third cryptographic key and the fourth cryptographic key are same, identical, or substantially identical.

The second user device can perform a cryptographic operation (e.g., with the third user device or with another user device) using the third cryptographic key, and the third user device can perform a cryptographic operation (e.g., with the second user device or with another user device) using the fourth cryptographic key. A cryptographic operation includes encrypting data, decrypting data, encrypting another cryptographic material (e.g., another cryptographic key), decrypting another cryptographic material, signing data, verifying data, signcrypting data, and so on. For example, one of the second user device or the third user device can encrypt, decrypt, sign, verify, or signcrypt data to be send to or data received from the other one of the second user device or the third user device.

In some arrangements such as those described with respect to the method 600, the first cryptographic material and the second cryptographic material are different. For example, the first cryptographic material is a first random number, and the second cryptographic material is a second random number, and the first random number and the second random number are different. The first user device sends the first random number to the second user device, and the second user device sends the second random number to the first user device.

The first user device determines a cryptographic key using the first random number and the received second random number (e.g., by XORing the first random number and the received second random number). The second user device determines the same, identical, or substantially identical cryptographic key using the second random number and the received first random number (e.g., by XORing the second random number and the received first random number).

In some examples, the method 800 includes sending, by the roving cryptography device to a third user device (e.g., the user device 120d or 520c) of the plurality of user devices, a third cryptographic material when the roving cryptography device is at a third location along the path of the roving cryptography device. The third location is different from the first location and the second location. The second user device and the third user device establish another cryptographic key using the second cryptographic material and the third cryptographic material. The another cryptographic key is different from the first and second cryptographic key.

For example, the third cryptographic material includes a third random number different from the first random number and the second random number. The third user device sends the third random number to the second user device. The second user device determines a third cryptographic key using the second random number and the received third random number (by XORing the second random number and the received third random number). The third user device determines a fourth cryptographic key using the third random number and the received second random number (by XORing the third random number and the received second random number). The third cryptographic key and the fourth cryptographic key are same, identical, or substantially identical.

The second user device can perform a cryptographic operation (e.g., with the third user device or with another user device) using the third cryptographic key, and the third user device can perform a cryptographic operation (e.g., with the second user device or with another user device) using the fourth cryptographic key. A cryptographic operation includes encrypting data, decrypting data, encrypting another cryptographic material (e.g., another cryptographic key), decrypting another cryptographic material, signing data, verifying data, signcrypting data, and so on. For example, one of the second user device or the third user device can encrypt, decrypt, sign, verify, or signcrypt data to be send to or data received from the other one of the second user device or the third user device.

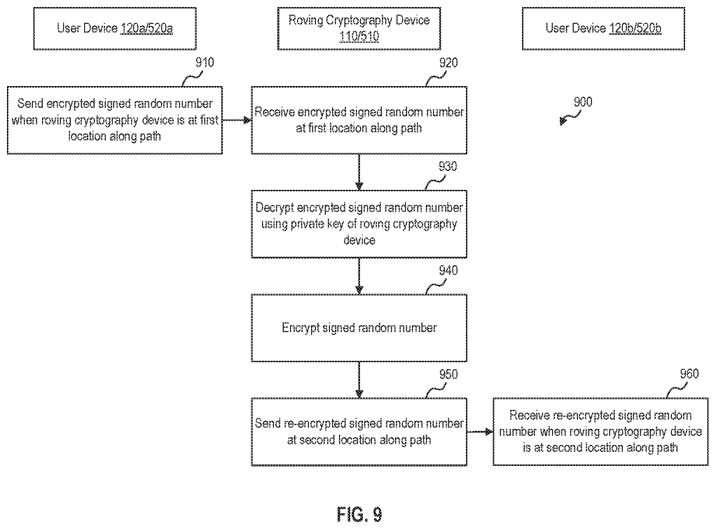

FIG. 9 is a flowchart diagram illustrating a method 900 for a roving cryptography device (e.g., 110 or 510) to provide cryptographic materials to a plurality of user devices (e.g., 120a, 120b, 120c, 120d, 520a, 520b, and 520c), according to various arrangements. The method 700 is an example implementation of the method 900. As used herein a first user device and a second user device can be any of the user devices 120a, 120b, 120c, 120d, 520a, 520b, and 520c. For example, the user device 120a or 520a can be referred to as a first user device, and the user device 120b or 520b can be referred to as a second user device. Blocks 920, 930, 940, and 950 can be performed by the roving cryptography device. Block 910 can be performed by the first user device. Block 960 can be performed by the second user device.

At 910, the first user device sends an encrypted signed random number generated by the first user device when the roving cryptography device is at a first location along a path of the roving cryptography device. At 920, the roving cryptographic device receives from the first user device an encrypted signed random number generated by the first user device when the roving cryptography device is at a first location along a path of the roving cryptography device. A signature on the random number is signed by the first user device using a private key of the first user device. The signed random number is encrypted using a public key of the first roving cryptography device.

At 930, the roving cryptography device decrypts the encrypted signed random number using a private key of the roving cryptography device. At 940, the roving cryptography device encrypt the signed random number using a public key of a second user device to generate a re-encrypted signed random number. At 950, the roving cryptography device sends to the second user device the re-encrypted signed random number when the roving cryptography device is at a second location along the path of the roving cryptography device. The first location and the second location are different locations. The first user device cannot receive any information or send any information to the roving cryptography device when the roving cryptography device is in the second location. The second user device cannot receive any information or send any information to the roving cryptography device when the roving cryptography device is in the first location.

In some arrangements, the second user device decrypts the re-encrypted signed random number using a private key of the second user device. The second user device verifies the signature in the decrypted signed random number using a public key of the first user device. The roving cryptography device sends the public key of the first user device to the second user device.

In some arrangements, the method 900 further includes encrypting, by the roving cryptography device, the signed random number using a public key of a third user device to generate another re-encrypted signed random number and sending, by the roving cryptography device to the third user device, the another re-encrypted signed random number when the roving cryptography device is at a third location along the path of the roving cryptography device. The third location is different from the first location and the second location. The third user device decrypts the another re-encrypted signed random number using a private key of the third user device. The third user device verifies the signature in the decrypted signed random number using a public key of the first user device. The roving cryptography device sends the public key of the first user device to the third user device.

The communications (e.g., transmission and reception of data) between the roving cryptography device and a user device and the communications between two user devices can be performed over a suitable communication link shown as arrows in FIGS. 1-8. Each of the communication link can be a wireless communication link such as any suitable Local Area Network (LAN), Wide Area Network (WAN), satellite communication network, or a combination thereof. For example, each communication link can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1x Radio Transmission Technology (lx), General Packet Radio Service (GPRS), Personal Communications Service (PCS), 802.11X, ZigBee, Bluetooth, Wi-Fi, non-radio frequency communication networks (such as infrared networks, ultraviolet networks, laser networks), a combination thereof, and/or the like. Each communication link is structured to permit the exchange of data, values, parameters, signals, instructions, messages, and the like.

Communications via these links are secured using industry cryptographic protocols such as TLS, Secure Shell Protocol (SSH), Internet Protocol Security (IPsec), including PQC algorithms with X.509 (single-key or dual-key) certificates, Pre-Shared Keys (PSK) methods, protocols that utilize Quantum Key Distribution (QKD) capabilities, and so on. Such cryptographic protocols require the user devices to use cryptographic materials to perform encrypt, decrypt, sign, signcrypt, validate, authenticate, or protect sensitive information and communications according to those cryptographic protocols. In the examples in which the cryptographic material includes cryptographic key, the user device can use the cryptographic key to directly perform encrypt, decrypt, sign, signcrypt, validate, authenticate, or protect sensitive information and communications over such communication link. In the examples in which cryptographic material includes information used to generate or derive a cryptographic key, the user device can use the information to derive a cryptographic key to perform encrypt, decrypt, sign, signcrypt, validate, authenticate, or protect sensitive information and communications over such communication link.

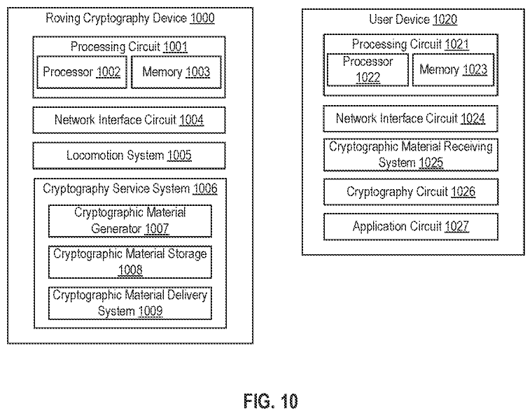

FIG. 10 illustrates block diagrams of an example roving cryptography device 1000 and a user device 1020, according to some arrangements. The roving cryptography device 1000 is an example of each of the roving cryptography devices 110 and 510. The user device 1020 is an example of each of the user devices 120a, 120b, 120c, 120d, 520a, 520b, and 520c.

The roving cryptography device 1000 can be a mobile, unmanned vehicle such as a drone, UAV, UGV, UMV, airplanes, gliders, satellite, HAPS, and so on. The roving cryptography device 1000 is shown to include various circuits and logic for implementing the operations described herein. More particularly, the roving cryptography device 1000 includes one or more of a processing circuit 1001, a network interface circuit 1004, a location motion system 1005, and a cryptography service system 1006. While various circuits, interfaces, and logic with particular functionality are shown, it should be understood that the roving cryptography device 1000 includes any number of circuits, interfaces, and logic for facilitating the operations described herein. For example, the activities of multiple circuits are combined as a single circuit and implemented on a same processing circuit (e.g., the processing circuit 1001), as additional circuits with additional functionality are included.

In some arrangements, the processing circuit 1001 includes a processor 1002 and a memory 1003. The processor 1002 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 1003 (e.g., Random Access Memory (RAM), Read-Only Memory (ROM), Non-Volatile RAM (NVRAM), flash memory, hard disk storage, etc.) stores data and/or computer code for facilitating the various processes described herein. Moreover, the memory 1003 is or includes tangible, non-transient volatile memory or non-volatile memory. Accordingly, the memory 1003 includes database components, object code components, script components, or any other type of information structure for supporting the various activities and information structures described herein. The processing circuit 1001 can be used to implement or control one or more of the circuits or systems 1004, 1005, and 1006.

The network interface circuit 1004 is configured for and structured to establish and implement one or more communication links with user devices. For example, the network interface circuit 1004 can establish one or more communication links with network interface circuits 1024 of the user devices 1020 in the manner described to send data (e.g., cryptographic materials) to and receive data (e.g., cryptographic materials) from the user device 1020 in the manner described. Accordingly, the network interface circuit 1004 includes any of a cellular transceiver (for cellular standards), wireless network transceiver (for 802.11X, ZigBee, Bluetooth, Wi-Fi, or the like), satellite communication transceiver (for satellite communication standards), or a combination thereof. For example, the network interface circuit 1004 may include wireless network modems, ports, baseband processors, and associated software and firmware.

The locomotion system 1005 includes any system configured for movement and propulsion. In the examples in which the roving cryptography device 1000 includes a drone, UAV, UGV, UMV, airplanes, gliders, and so on, the locomotion system 1005 includes motors, engines, tires, wheels, tracks, robotic legs or limbs, rotors, propellers, sails, and so on. In the examples in which the roving cryptography device 1000 includes a satellite, the locomotion system 1005 includes chemical propulsion systems, chemical thrusters, electric propulsion systems, rockets, and so on. In the examples in which the roving cryptography device 1000 incudes HAPS, the locomotion system 1005 includes motors, engines, rotors, propellers, and so on. The locomotion system 1005 also includes fuel, battery, power supply, solar panels, etc. used to provide for energy needed to effectuate motion. The locomotion system 1005 can be implemented using the processing circuit 1001, which can control the movement, navigation, pathing, obstacle avoidance by controlling the locomotion system 1005.

The cryptography service system 1006 can provide cryptographic materials to the user device 1020. The cryptography service system 1006 can include a cryptographic material generator 1007, a cryptographic material storage 1008, and a cryptographic material delivery system 1009.

The cryptographic material generator 1007 is configured to generate a cryptographic material. In some examples, the cryptographic material generator 1007 is configured to generate information (e.g., a secret parameter, a random number, a seed, a key component, an initialization vector, a salt, and so on) used to generate or derive a cryptographic key. For example, the cryptographic material generator 1007 can include a random number generator, a pseudo-random number generator, or a Quantum Random Number Generator (QRNG) to generate a random number. For example, the QRNG can include a quantum entropy having a quantum entropy source to generate a stream of quantum particles (entangled or regular), such as photons containing information such as a string of binary zeroes and ones to be measured by an entropy measure function to generate random bits. In other words, the stream of quantum particles can be interpreted as a random number. In some examples, the cryptographic material generator 1007 can implement a Key Derivation Function (KDF) to generate or derive a cryptographic key using the information (e.g., a secret parameter, a random number, a seed, a key component, an initialization vector, a salt, and so on).

The cryptographic material storage 1008 includes any suitable memory device, database, datacenter, Key Management Infrastructure (KMI), HSM, and so on that can securely store sensitive information such as the cryptographic material.

The cryptographic material delivery system 1009 is configured to deliver the cryptographic material stored in the cryptographic material storage 1008 or generated by the cryptographic material generator 1007 to one or more user devices 1020. In some examples, the cryptographic material delivery system 1009 can use the network interface circuit 1004 to wirelessly transmit the cryptographic material via a communication link.

The user device 1020 can include a suitable computing system such as a base station, a ground station, a desktop computer, laptop computer, smart phone, tablet, server, on-premise computing system, datacenter, cloud computing system, and so on. The user device 1020 is shown to include various circuits and logic for implementing the operations described herein. More particularly, the user device 1020 includes one or more of a processing circuit 1021, a network interface circuit 1024, a cryptographic material receiving system 1025, a cryptography circuit 1026, and an application circuit 1027. While various circuits, interfaces, and logic with particular functionality are shown, it should be understood that the user device 1020 includes any number of circuits, interfaces, and logic for facilitating the operations described herein. For example, the activities of multiple circuits are combined as a single circuit and implemented on a same processing circuit (e.g., the processing circuit 1021), as additional circuits with additional functionality are included.

In some arrangements, the processing circuit 1021 has a processor 1022 and memory 1023. The processor 1022 is a processing component such as the processor 1002. The memory 1023 is a memory device such as the memory 1003. The processing circuit 1021 can be used to implemented one or more of the circuits 1024, 1025, 1026, and 1027.

The network interface circuit 1024 is configured for and structured to establish and implement one or more communication link with the network interface 1004 of the roving cryptography device 1000. Accordingly, the network interface circuit 1024 includes any of a cellular transceiver (for cellular standards), wireless network transceiver (for 802.11X, ZigBee, Bluetooth, Wi-Fi, or the like), satellite communication transceiver (for satellite communication standards), or a combination thereof. For example, the network interface circuit 1024 may include wireless network modems, ports, baseband processors, and associated software and firmware.

The cryptographic material receiving system 1025 is configured to receive the cryptographic material from a roving cryptography device 1000. In some examples, the cryptographic material receiving system 1025 can use the network interface circuit 1024 to wirelessly receive the cryptographic material via the communication link with the roving cryptography device 1000.

The cryptography circuit 1026 is configured to derive cryptographic keys using the received cryptographic materials and perform cryptographic operations using the cryptographic materials received and the derived cryptographic keys. In some examples, the cryptography circuit 1026 can be considered as a cryptographic software module implemented using one or more of software, firmware, and hardware. In some examples, the cryptography circuit 1026 can be included in or embodied as an HSM. For example, the HSM meets Federal Information Processing Standard (FIPS) 140-3 security level 3 or higher. In the examples in which the cryptography circuit 1026 or the entire user device 1020 is an HSM, the user device 1020 can be physically connected to another device (e.g., a smartphone, a laptop, a tablet and so on), the roving cryptography device 1000 can connect wirelessly and securely to the cryptography circuit 1026 to exchange cryptographic materials (stored in the cryptographic material storage 1008) or other encrypted data (stored in the memory 1003). For example, the cryptography circuit 1026 can perform, using the received cryptographic material, cryptographic operations such as encrypting data, decrypting data, encrypting another cryptographic material (e.g., another cryptographic key), decrypting another cryptographic material, signing data, verifying data, signcrypting data, and so on. In some examples, the cryptography circuit 1026 can use the cryptographic key derived for encrypting data, decrypting data, encrypting another cryptographic material (e.g., another cryptographic key), decrypting another cryptographic material, signing data, verifying data, signcrypting data, and so on. In the examples, the cryptography circuit 1026 can implement a KDF to generate or derive a cryptographic key using the information (e.g., a secret parameter, a random number, a seed, a key component, an initialization vector, a salt, and so on).

The application circuit 1027 executes an application, software, firmware, or code for which cryptographic operations are needed to encrypt data, decrypt data, encrypt another cryptographic material, decrypt another cryptographic material, sign data, verify data, signcrypt data, and so on. For example, the application circuit 1027 can execute base or ground station communication protocol, a mobile banking application, mobile wallet, a browser, a word processing application, a mobile banking application, a mobile wallet, a Graphic User Interface (GUI), an email reader/client, a File Transfer Protocol (FTP) client, a virtual machine application and so on. For example, application circuit 1027 can execute an application, software, firmware, or code for which data (e.g., message, code, document, file, program or application, etc.) needs to be encrypted, decrypted, signed, or for which a signature on the signed data needs to be verified.

In some examples, the roving cryptography device 1000 can be dispatched or instructed to move to the locations along the path to provide cryptographic materials to the user devices in sequence. That is, the roving cryptography device 1000 can be moved using their respective locomotion systems 1005 or passively along a path as in the case of some satellites to designated locations periodically (every day, every week, every month, and so on) or according to a scheduled time. The schedule can include at least one designated location for the roving cryptography device 1000 and a corresponding time for each of the at least one designated location. In response to the server determining that it is the time to move to the locations according to the schedule, the server sends a command to roving cryptography device 1000 with its respective locations to trigger the deployment. In the examples in which the schedule is provided to the roving cryptography device 1000 in advance, in response to roving cryptography device 1000 determining that it is the time to move to a respective location (defined by suitable coordinates such as Global Positioning System (GPS) coordinates), roving cryptography device 1000 moves to that location using suitable navigation system and propulsion system in the locomotion system 1005. A server for managing the roving cryptography devices 1000, which includes suitable processing capabilities (e.g., at least one processor and at least one memory), can be configured to pre-load, update, or dynamically send the schedule and the corresponding coordinates for each roving cryptography device 1000 via one or more suitable networks.

In some examples, the schedule of a roving cryptography device 1000 can correspond to a predetermined path of the one or more of the roving cryptography device 1000. In the example in which a roving cryptography device is a satellite with a predetermined path (e.g., orbit) passing over various locations on the earth surface, the times by which the satellite pass over certain locations (defined by sets of coordinates) correspond to the schedule. In other words, the schedule can be implicit and is continuously implemented. The cell of the satellite can continue to change according to the predetermined path, and the satellite can provide communication services and cryptography services for a user device when and while the user device is within a cell corresponding to a current location of the satellite.

In some examples, the roving cryptography device 1000 can be dispatched or instructed to move to their respective locations to form the network in response to detecting an adverse event. The server for managing the roving cryptography device 1000 can receive information regarding the adverse event such as a location or area of the adverse event as defined by a set of coordinates (e.g., GPS coordinates) and assigns locations for the roving cryptography device 1000 to cover the location or area of the adverse event. In response to a roving cryptography device 1000 receiving coordinates for locations within or next to an area of the adverse event, the roving cryptography device 1000 moves to those locations in sequence using suitable navigation system and propulsion system in the locomotion system 1005, thus forming path. The locations the roving cryptography device 1000 are intended to cover the user devices within the adverse event.

In some examples, the roving cryptography device 1000 can be dispatched or instructed to move to respective locations based on locations of user devices 1020. A user device 1020 can include a geolocation circuit (e.g., a GPS system) configured to determine a location of the user device 1020. The server for managing the roving cryptography devices 1000 can monitor a locations of the user devices 1020. The server instructs a roving cryptography device 1000 to provide the cryptographic materials at the current locations of multiple user devices 1020 in sequence, forming the path. The server or the user devices 1020 can send the updated locations to the roving cryptography device 1000 as the roving cryptography device 1000 moves toward one or more user devices 1020.

As utilized herein, the terms “approximately,” “substantially,” and similar terms are intended to have a broad meaning in harmony with the common and accepted usage by those of ordinary skill in the art to which the subject matter of this disclosure pertains. It should be understood by those of ordinary skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

Although only a few arrangements have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative arrangements. Other substitutions, modifications, changes, and omissions may also be made in the design, operating conditions and arrangement of the various exemplary arrangements without departing from the scope of the present disclosure.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may include or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), a distributed ledger (e.g., a blockchain), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web arrangements of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

What is claimed is:

1. A method, comprising:
sending, by a roving cryptography device to a first user device of a plurality of user devices, a first cryptographic material when the roving cryptography device is at a first location along a path of the roving cryptography device; and
sending, by the roving cryptography device to a second user device of the plurality of user devices, a second cryptographic material when the roving cryptography device is at a second location along the path of the roving cryptography device, wherein the first location and the second location are different locations, and wherein the first user device and the second user device establish a cryptographic key using the first cryptographic material and the second cryptographic material.

2. The method of claim 1, wherein the cryptographic material comprises at least one of a random number, a key component, or a key share.

3. The method of claim 1, wherein the roving cryptography device comprises a drone, an Unmanned Ariel Vehicle (UAV), an Unmanned Ground Vehicle (UGV), an Unmanned Maritime Vehicle (UMV), an airplane, a glider, a satellite, or a High Altitude Platform System (HAPS).

4. The method of claim 1, wherein each of the plurality of user devices comprises a base station, a ground station, a desktop computer, a laptop computer, a smart phone, a tablet, a server, an on-premise computing system, a datacenter, or a cloud computing system.

5. The method of claim 1, wherein the first cryptographic material and the second cryptographic material are identical.

6. The method of claim 1, wherein
the first cryptographic material and the second cryptographic material comprise a same first random number;
the first user device determines a first shared secret by combining the first random number with a second random number generated by the first user device and sends the first shared secret to the second user device; and
the second user device determines a second shared secret by combining the first random number with a third random number generated by the second user device and sends the second shared secret to the first user device.

7. The method of claim 6, wherein
the first user device determines the third random number using the received second shared secret and the first random number;
the first user device determines a cryptographic key using the second random number and the determined third random number;
the second user device determines the second random number using the received first shared secret and the first random number; and
the second user device determines the cryptographic key using the third random number and the determined second random number.

8. The method of claim 6, further comprising sending, by the roving cryptography device to a third user device of the plurality of user devices, a third cryptographic material when the roving cryptography device is at a third location along the path of the roving cryptography device, wherein the third location is different from the first location and the second location, wherein the second user device and the third user device establish another cryptographic key using the second cryptographic material and the third cryptographic material, and wherein the cryptographic key and the another cryptographic key are different.

9. The method of claim 8, wherein
the first cryptographic material, the second cryptographic material, and the third cryptographic material comprise a same first random number;
the second user device determines a second shared secret by combining the first random number with a third random number generated by the second user device and sends the second shared secret to the third user device; and
the third user device determines a third shared secret by combining the first random number with a fourth random number generated by the third user device and sends the third shared secret to the second user device.

10. The method of claim 9, wherein
the second user device determines the fourth random number using the received third shared secret and the first random number;
the second user device determines the another cryptographic key using the third random number and the determined fourth random number;
the third user device determines the third random number using the received second shared secret and the first random number; and
the second user device determines the another cryptographic key using the fourth random number and the determined third random number.

11. The method of claim 1, wherein the first cryptographic material and the second cryptographic material are different.

12. The method of claim 1, wherein
the first cryptographic material comprise a first random number and the second cryptographic material comprises a second random number, wherein the first random number and the second random number are different;
the first user device sends the first random number to the second user device; and
the second user device sends the second random number to the first user device.

13. The method of claim 12, wherein
the first user device determines a cryptographic key using the first random number and the received second random number; and
the second user device determines the cryptographic key using the second random number and the received first random number.

14. The method of claim 12, further comprising sending, by the roving cryptography device to a third user device of the plurality of user devices, a third cryptographic material when the roving cryptography device is at a third location along the path of the roving cryptography device, wherein the third location is different from the first location and the second location, wherein the second user device and the third user device establish another cryptographic key using the second cryptographic material and the third cryptographic material, and wherein the cryptographic key and the another cryptographic key are different.

15. The method of claim 14, wherein
the third cryptographic material comprises a third random number different from the first random number and the second random number;
the third user device sends the third random number to the second user device;
the second user device determines the another cryptographic key using the second random number and the received third random number; and
the third user device determines the another cryptographic key using the third random number and the received second random number.

16. A system, comprising:
at least one processor of a roving cryptography device, configured to:
send to a first user device of a plurality of user devices a first cryptographic material when the roving cryptography device is at a first location along a path of the roving cryptography device; and
send to a second user device of the plurality of user devices, a second cryptographic material when the roving cryptography device is at a second location along the path of the roving cryptography device, wherein the first location and the second location are different locations, and wherein the first user device and the second user device establish a cryptographic key using the first cryptographic material and the second cryptographic material.

17. The system of claim 16, wherein
the second user device decrypts the re-encrypted signed random number using a private key of the second user device; and
the second user device verifies the signature in the decrypted signed random number using a public key of the first user device, wherein the roving cryptography device sends the public key of the first user device to the second user device.

18. A method, comprising:
receiving, by a roving cryptography device from a first user device, an encrypted signed random number generated by the first user device when the roving cryptography device is at a first location along a path of the roving cryptography device, wherein a signature on the random number is signed by the first user device using a private key of the first user device, and wherein the signed random number is encrypted using a public key of the first roving cryptography device;
decrypting, by the roving cryptography device, the encrypted signed random number using a private key of the roving cryptography device;
encrypting, by the roving cryptography device, the signed random number using a public key of a second user device to generate a re-encrypted signed random number; and
sending, by the roving cryptography device to the second user device, the re-encrypted signed random number when the roving cryptography device is at a second location along the path of the roving cryptography device, wherein the first location and the second location are different locations.

19. The method of claim 18, wherein
the second user device decrypts the re-encrypted signed random number using a private key of the second user device; and
the second user device verifies the signature in the decrypted signed random number using a public key of the first user device, wherein the roving cryptography device sends the public key of the first user device to the second user device.

20. The method of claim 19, further comprising:
encrypting, by the roving cryptography device, the signed random number using a public key of a third user device to generate another re-encrypted signed random number; and
sending, by the roving cryptography device to the third user device, the another re-encrypted signed random number when the roving cryptography device is at a third location along the path of the roving cryptography device, wherein the third location is different from the first location and the second location, and wherein the third user device decrypts the another re-encrypted signed random number using a private key of the third user device, and the third user device verifies the signature in the decrypted signed random number using a public key of the first user device, wherein the roving cryptography device sends the public key of the first user device to the third user device.
